(19) United States
(12) Patent Application Publication
(10) Pub. No.: US 2015/0072309 A1
(43) Pub. Date: Mar. 12, 2015

(54) DENTAL IMPLANT MEMBER

(71) Applicant: Shih-Cheng WEN, New Taipei City (TW)

(72) Inventor: Shih-Cheng WEN, New Taipei City (TW)

(21) Appl. No.: 14/257,488

(22) Filed: Apr. 21, 2014

(30) Foreign Application Priority Data
Sep. 11, 2013 (TW) 102217103

(51) Int. Cl. A61C 8/00

(52) U.S. Cl. CPC A61C 8/0068; A61C 8/006; A61C 8/0069
USPC 433/173

(57) ABSTRACT

A dental implant member includes an implant body for implanting into an alveolar bone, the implant body having an axial hole with a truncated cone-shaped section defined by a polygonal inner wall surface; a dental base including a low inset having a truncated cone-shaped section defined by a polygonal outer wall surface for inserting into the axial hole in such a manner that the polygonal inner and outer wall surfaces of the implant body and the dental base cooperatively define a fault-tolerance space therebetween; and a fastener unit for extending through the dental base so as to fasten the dental base securely on the implant body.

This application claims the benefits of the Taiwan Patent Application Serial NO. 102217103, filed on Sep. 11, 2013 the subject matter of which is incorporated herein by reference.

### BACKGROUND OF THE INVENTION

1. Field of the Invention

The present invention relates to a dental implant member, more particularly to dental implant member including a truncated cone-shaped insert and an implant body having an axial hole with a truncated cone-shaped section for receiving the truncated cone-shaped insert therein.

2. Description of the Prior Art

Referring to FIGS. 1 to 2B, wherein FIG. 1 is a partly exploded view of a dental implant member of the prior art; FIG. 2 is a cross-sectional view of the dental implant member of the prior art; FIG. 2A is an enlarged view of an encircled portion (A) in FIG. 2 and FIG. 2B is an enlarged view of an encircled portion (B) in FIG. 2. As illustrated in FIG. 1, the prior art dental implant member PA100 generally includes an implant body PA1, a dental base PA2 and a fastener unit PA3. For implanting process, the implant body PA1 is first of all implanted into an alveolar bone (i.e., jaw bone), after which, the dental base PA 2 provided with a crown (not shown) is mounted on the implant body PA1 securely via the fastener unit PA3.

As best shown in FIG. 2, owing to restricted working space, the patient must open his mouth large enough all the time so as allow the dental tool to drill a tooth socket in the alveolar bone PA200. In case of drilling a plurality of teeth sockets in the alveolar bone, it is relatively difficult for the dentist to drill the teeth sockets to be parallel with one another. Under this condition, once the implant bodies PA1a, PA1b, PA1c are implanted into the teeth sockets PA11a, PA11b, PA11c, there may form non-alignment among the implanted implant bodies PA1a, PA1b, PA1c. Even though the dental bases PA2a, PA2b, PA2c respectively have lower cylindrical inserts PA21a, PA21b, PA21c, the dentist may encounter a great difficulty in aligning the cylindrical inserts PA21a, PA21b, PA21c relative to the teeth sockets PA11a, PA11b, PA11c. Even if the dentist can succeed to align the middle cylindrical insert PA21b with the corresponding tooth socket PA11b, he is unable to align the other cylindrical inserts PA21a, PA21c with the remaining teeth sockets PA11a, PA11c, thereby resulting in non-alignment between the cylindrical inserts PA21a, PA21c and the remaining teeth sockets PA11a, PA11c so that the cylindrical inserts PA21a, PA21c cannot be inserted snugly into the teeth sockets PA11a, PA11c. As best shown in FIGS. 2A and 2B, since bottom parts of the cylindrical inserts PA21a, PA21c may collide against upper parts of the teeth sockets PA11a, PA11c, thereby preventing snugly fitting of the cylindrical inserts PA21a, PA21c within the teeth sockets PA11a, PA11c. In case of forcefully pressing the cylindrical inserts PA21a, PA21c into the teeth sockets PA11a, PA11c, damage may be resulted in the teeth sockets PA11a, PA11c and finally leading to discomfort and injury to the patient. At the same time, the row of crowns PA300 cannot be attached onto or removed from the dental bases PA2a, PA2b, PA2c, thereby resulting in great difficulties in the clinical treatment. Hence, implanting a row of dental implants can not be conducted on an improper alveolar bone, except that the dental implant can be conducted only in one-by-one basis.

Referring to FIGS. 3 and 4, wherein FIG. 3 is an exploded view of another dental implant member of the prior art and FIG. 4 is a perspective view of the another dental implant member of the prior art, which is implanted in one-by-one basis. As illustrated, a crown 300d is provided on the dental base (not visible) that has a truncated cone-shaped insert PA21d for inserting into the implant body PA1d. However, since there is no interference performance between the cone-shaped insert PA21d and the axial hole PA11d in the implant body PA1d, a relative movement may be resulted between the dental base and the implant body PA1d, which, in turn, results in non precision of mounting of the crown PA300d relative to the dental base.

### SUMMARY OF THE INVENTION

As stated above, when a plurality of crowns are mounted on the dental bases respectively, the latter can not be mounted smoothly on the implant bodies, thereby resulting in difficulties during the implanting process. In the prior art technique, even though the truncated cone-shaped insert is utilized for implanting into the implant body, since there is no interference between the cone-shaped insert and the axial hole in the implant body, a relative movement may be resulted between the dental base and the implant body. Hence the prior art technique is suitable for implanting dental implant member on one-by-one basis.

Therefore, the object of the present invention is to provide a dental implant member for implanting into an alveolar bone. The dental implant member includes an implant body having an axial hole with a truncated cone-shaped section defined by a polygonal inner wall surface; a dental base including a low inset, which has a truncated cone-shaped section defined by a polygonal outer wall surface and which is adapted for inserting into the axial hole in such a manner that the polygonal inner and outer wall surfaces of the implant body and the dental base cooperatively define a fault-tolerance space therebetween; and a fastener unit for extending through the dental base so as to fasten the dental base securely on the implant body.

In one embodiment of the present invention, the truncated cone-shaped section of the implant body is selected from a group consisting of a hexagon, a rectangle and an octagon.

In one embodiment of the present invention, the truncated cone-shaped section of the low insert is selected from a group consisting of a hexagon, a rectangle and an octagon.

Preferably, the axial hole in the implant body serves as a fastener for fastening the implant body securely to the fastener unit. In this embodiment, the axial hole in the implant body is a threaded hole while the fastener unit is a fastener bolt for fastening threadedly within the threaded hole in the implant body.

As stated above, in the present invention, owing to truncated cone-shaped section of the lower insert of the dental base and truncated cone-shaped section of the axial hole in the implant body, each of which is defined by polygonal wall surfaces, there may result in interference between the polygonal wall surfaces of the dental base the implant body, and thus preventing relative movement between the dental base the implant body and permitting mounting of a crown on the dental base one-by-one basis. In addition, the problem of bottom parts of the cylindrical inserts colliding against upper parts of the teeth sockets as encountered in the prior art dental implant member can be avoided, thereby facilitating the dentist for performing dental treatment in a more precise manner.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a partly exploded view of a dental implant member of the prior art;

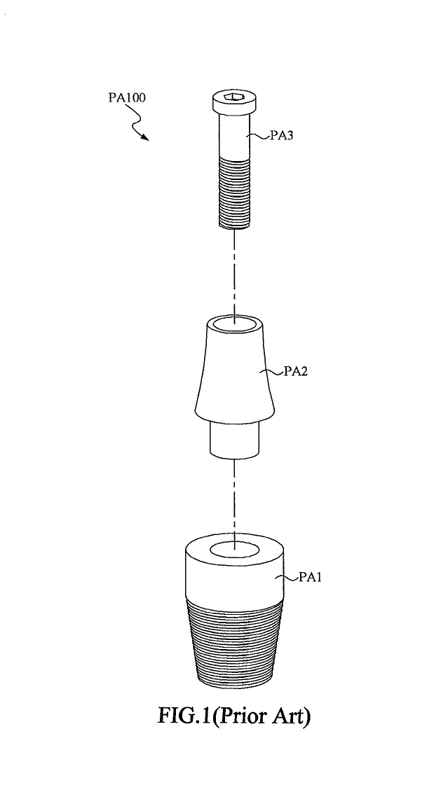

FIG. 2 is a cross-sectional view of the dental implant member of the prior art;

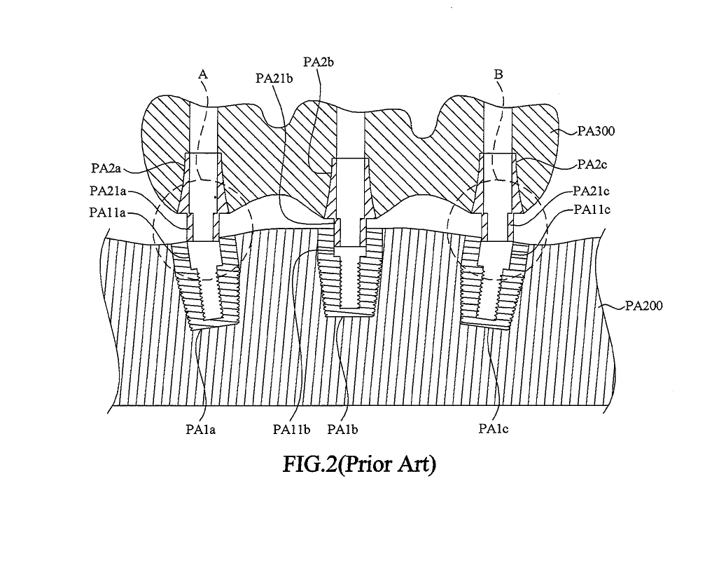

FIG. 2A is an enlarged view of an encircled portion (A) in FIG. 2;

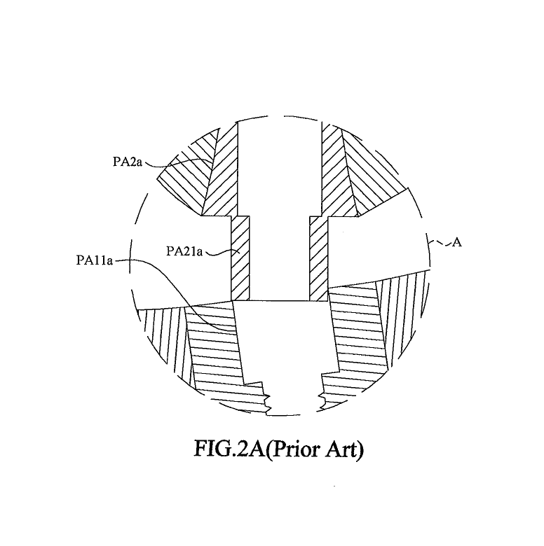

FIG. 2B is an enlarged view of an encircled portion (B) in FIG. 2;

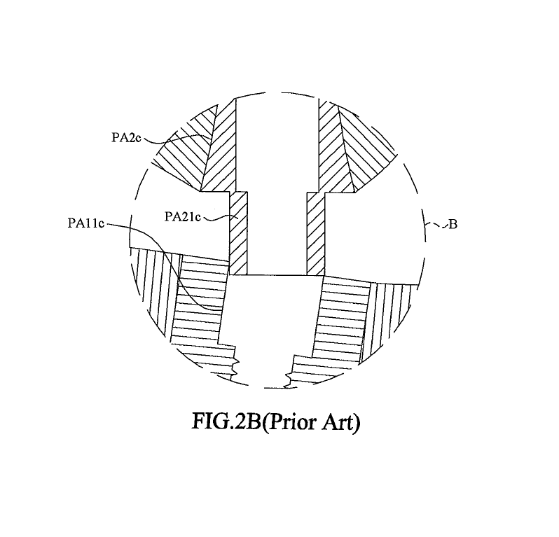

FIG. 3 is an exploded view of another dental implant member of the prior art;

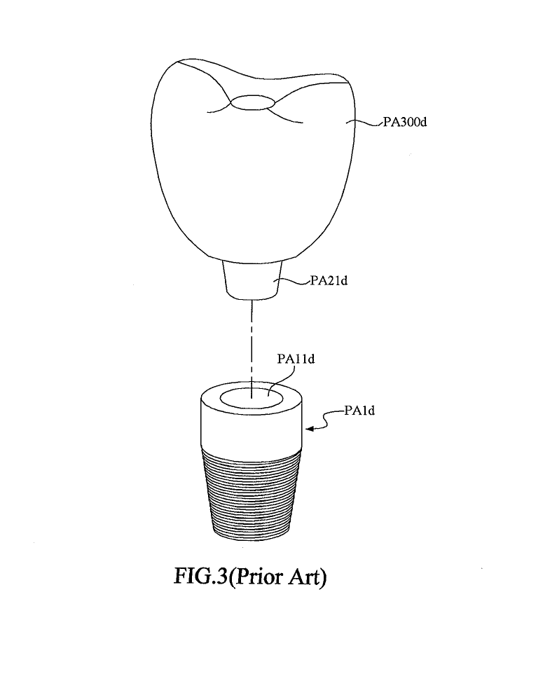

FIG. 4 is a perspective view of the another dental implant member of the prior art,

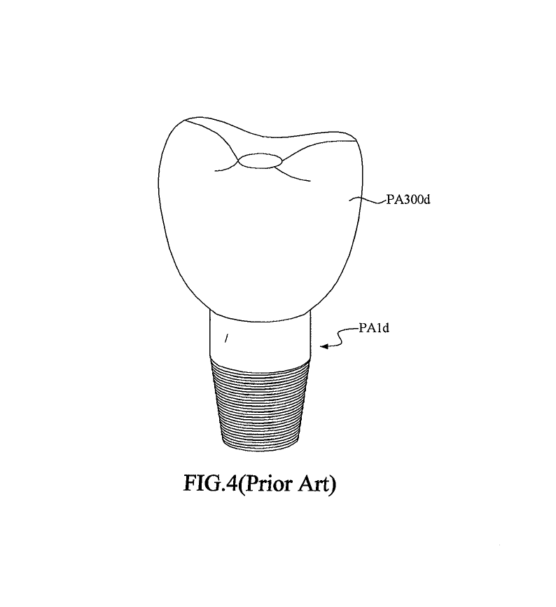

FIG. 5 is a partly perspective view of a dental implant member of present invention;

FIG. 6 is a partly exploded view of the dental implant member of the present invention;

FIG. 7 is a partly exploded and cross-sectional view of the dental implant member of the present invention along Line A-A in FIG. 6;

FIG. 8 is a partly perspective and cross-sectional view of the dental implant member of present invention;

FIG. 9 is an exploded and perspective view of the dental implant member of the present invention;

FIG. 10 is a cross-sectional view illustrating a plurality of the dental implant members of the present invention before fastening;

FIG. 10A is an enlarged view of an encircled portion (C) in FIG. 10;

FIG. 10B is an enlarged view of an encircled portion (D) in FIG. 10; and

FIG. 11 is a cross-sectional view illustrating a plurality of the dental implant members of the present invention after fastening.

### DETAILED DESCRIPTION OF THE PREFERRED EMBODIMENTS

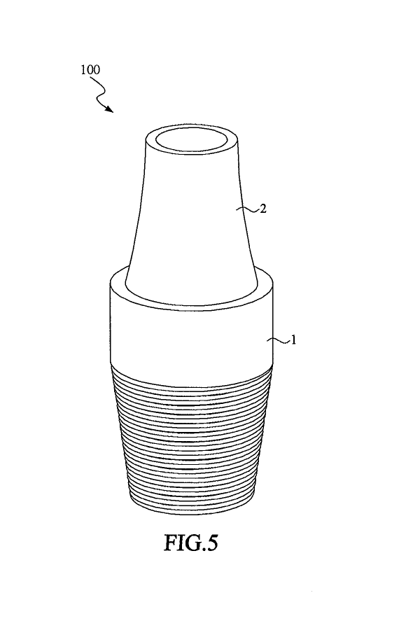

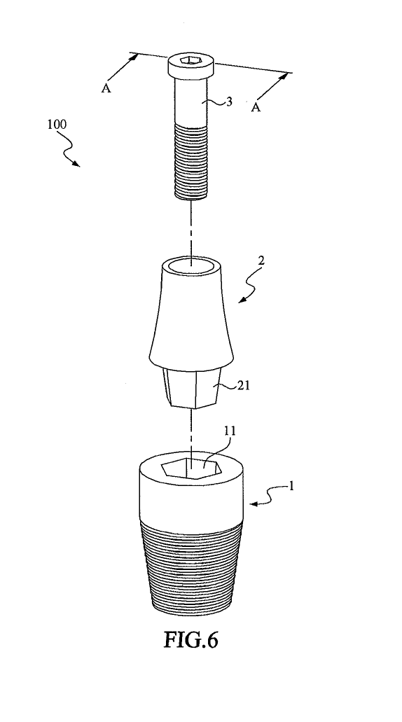

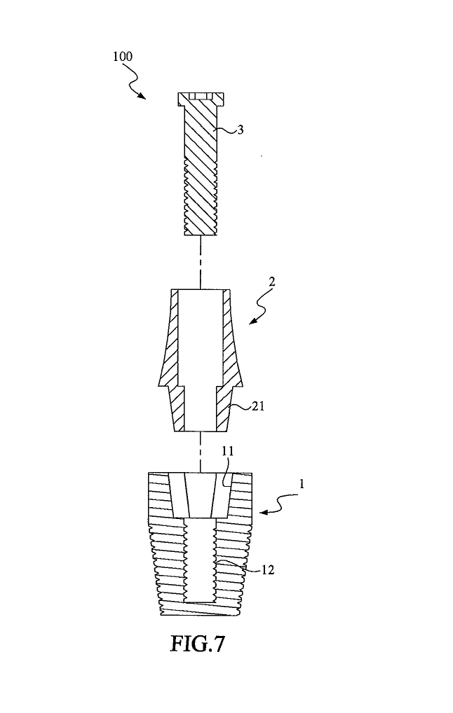

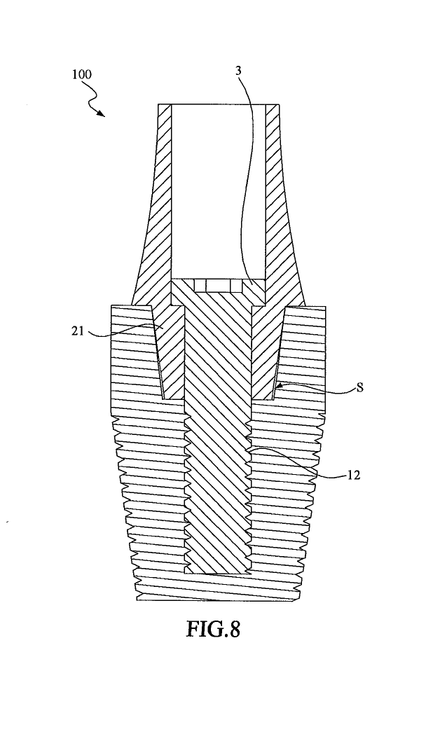

Referring to FIGS. 5 to 8, wherein FIG. 5 is a partly perspective view of a dental implant member of present invention; FIG. 6 is a partly exploded view of the dental implant member of the present invention; FIG. 7 is a partly exploded and cross-sectional view of the dental implant member of the present invention along Line A-A in FIG. 6; and FIG. 8 is a partly perspective and cross-sectional view of the dental implant member in FIG. 6 of present invention. As illustrated, the dental implant member 100 of the present invention includes an implant body 1, a dental base 2 and a fastener unit 3.

The implant body 1 is adapted to be implanted into an alveolar bone 200 (jaw bone), and has an axial hole 12 with a truncated cone-shaped section 11 defined by a polygonal inner wall surface. In this embodiment, the truncated cone-shaped section 11 is defined by hexagonal inner wall surfaces.

The dental base 2 includes a low inset 21 having a truncated cone-shaped section defined by a polygonal outer wall surface for inserting into the axial hole 12 in the implant body 1 in such a manner that the polygonal inner and outer wall surfaces of the implant body 1 and the dental base 1 cooperatively define a fault-tolerance space S therebetween. Preferably, the truncated cone-shaped section of the low insert 21 is selected from a group consisting of a hexagon, a rectangle and an octagon. In this embodiment, the low inset 21 is defined by hexagonal outer wall surfaces so as to match with the truncated cone-shaped section 11 of the implant body 1.

The fastener unit 3 extends through the dental base so as to fasten the dental base 2 securely on the implant body 1. In this embodiment, the axial hole 12 in the implant body 1 serves as a fastener for fastening securely to the fastener unit 3. Preferably, the axial hole 12 in the implant body 1 is a threaded hole while the fastener unit 3 is a fastener bolt for fastening threadedly within the threaded hole in the implant body 1.

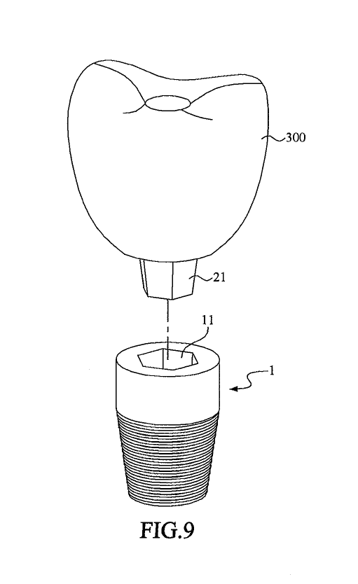

FIG. 9 is an exploded and perspective view of the dental implant member of the present invention and is adapted to be implanted in the alveolar bone on one-by-one basis. Note that, each of the truncated cone-shaped sections 11, 12 of the implant body 1 and the insert 21 is defined by hexagonal wall surfaces so as to cause interferences among the wall surfaces such that there is no relative movement between the implant body 1 and the dental base 2. Therefore, the crown 300 can be mounted securely on the implant body 1 via the fastener unit 3 such that the dental base 2 is not moved relative to the implant body 1 during rotation of the fastener unit 3 relative to the implant body 1.

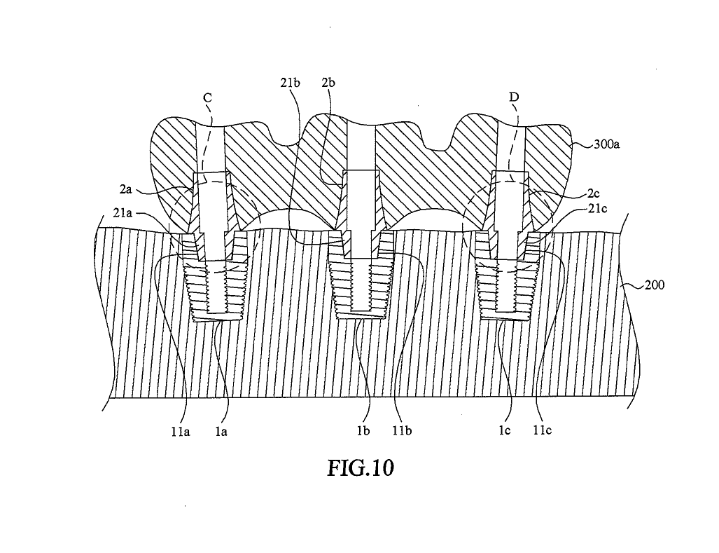

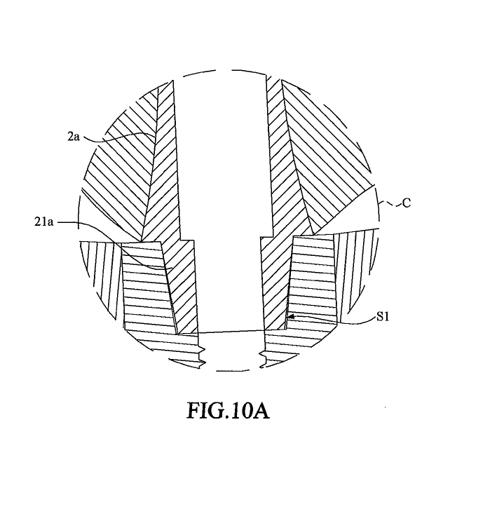

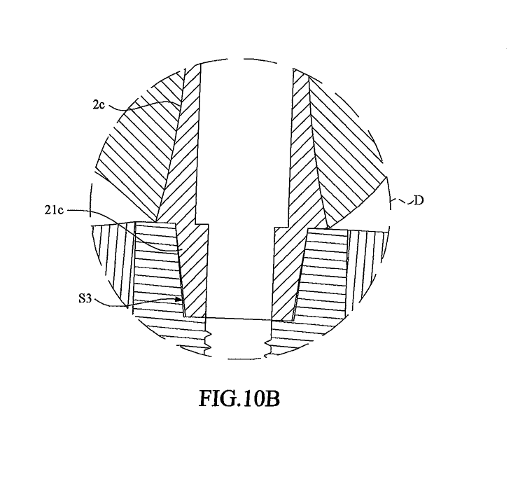

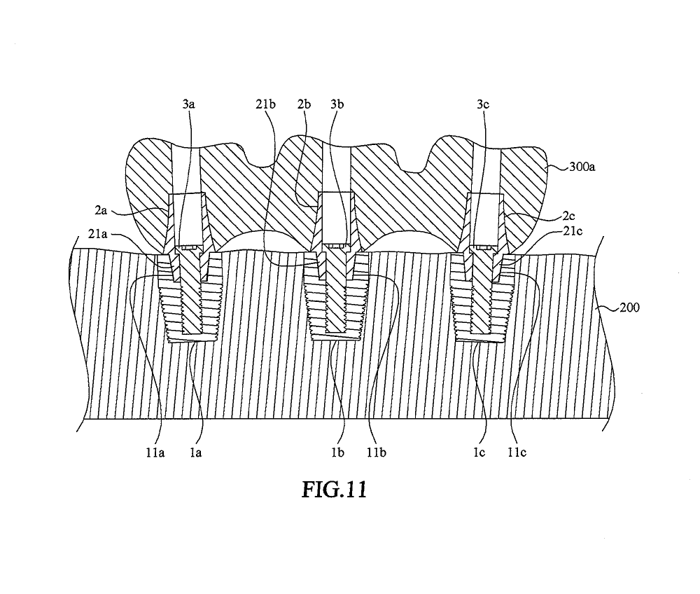

Referring to FIGS. 10 and 11, wherein FIG. 10 is a cross-sectional view illustrating a plurality of the dental implant members of the present invention before fastening; FIG. 10A is an enlarged view of an encircled portion (C) in FIG. 10; FIG. 10B is an enlarged view of an encircled portion (D) in FIG. 10; and FIG. 11 is a cross-sectional view illustrating a plurality of the dental implant members of the present invention after fastening. As illustrated, in practical application and for mounting a row of crowns 300a onto the alveolar bone 200 (not visible), a plurality of teeth sockets are drilled in the alveolar bone 200 using a dental drill, after which, a plurality of the implant bodies 1a, 1b, 1c are secured within the teeth sockets. It is to note that during the drilling of the teeth sockets in the alveolar bone, the teeth sockets may cause misalignment relative to one another owing to limited mouth opening of the patient and causing difficulties for the dentist. However, owing to the fault-tolerance space between the truncated cone-shaped sections 21a, 21b, 21c of the dental bases and the truncated cone-shaped sections 11a, 11b, 11c of the implant bodies 1a, 1b, 1c, the dental bases can be adjustably, snugly and securely fitted on the implant bodies 1a, 1b, 1c via the fastener units 3a, 3b, 3c.

Comparing with the prior art dental implant technique, when implanting several units of dental implant member, the cylindrical inserts of the dental bases cannot be fittingly implanted into the teeth sockets. In case of forcefully pressing the cylindrical inserts into the teeth sockets, the cylindrical inserts though can be inserted into the teeth sockets one-by-one basis regardless of non-alignment among the teeth sockets. However, the cylindrical inserts may rotate within the axial holes in the implant bodies and finally leading to relative movement between the dental bases and the implant bodies. Hence, the crowns cannot be mounted precisely on the dental bases. In the present invention, owing to truncated cone-shaped section of the lower insert of the dental bases and truncated cone-shaped section of the axial hole in the implant body, each of which is defined by polygonal wall surfaces, there may result in interference between the polygonal wall surfaces of the dental base the implant body, and thus preventing relative movement between the dental base the implant body and permitting mounting of a crown on the dental base one-by-one basis. In addition, owing to the fault-tolerance space between the truncated cone-shaped section of the lower insert of the dental bases and the truncated cone-shaped section of the implant body, a plurality of dental bases can be fittingly mounted on the implant bodies via the faster units regardless of non-alignment among the teeth sockets. Hence, a row of crowns can be mounted on the dental bases and facilitating the dentist to perform dental treatment.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A dental implant member 100 comprising:
an implant body for implanting into an alveolar bone, said implant body having an axial hole with a truncated cone-shaped section defined by a polygonal inner wall surface;
a dental base including a low inset having a truncated cone-shaped section defined by a polygonal outer wall surface for inserting into said axial hole in said implant body in such a manner that said polygonal inner and outer wall surfaces of said implant body and said dental base cooperatively define a fault-tolerance space therebetween; and
a fastener unit for extending through said dental base so as to fasten said dental base securely on said implant body.

2. The dental implant member according to claim 1, wherein said truncated cone-shaped section of said implant body is selected from a group consisting of a hexagon, a rectangle and an octagon.

3. The dental implant member according to claim 1, wherein said truncated cone-shaped section of said low insert is selected from a group consisting of a hexagon, a rectangle and an octagon.

4. The dental implant member according to claim 1, wherein said axial hole of said implant body serves as a fastener for fastening securely to said fastener unit.

5. The dental implant member according to claim 4, wherein said axial hole of said implant body is a threaded hole.

6. The dental implant member according to claim 4, wherein said fastener unit is a fastener bolt for fastening threadedly within said threaded hole in said implant body.
